(19) United States
(12) Patent Application Publication
(10) Pub. No.: US 2026/0020076 A1
(43) Pub. Date: Jan. 15, 2026

(54) LOCATION-BASED RANDOM ACCESS

(71) Applicants: Huawei Technologies Canada Co., Ltd., Ottawa (CA); DALHOUSIE UNIVERSITY, Halifax (CA)

(72) Inventors: Roshanak Soltani, Halifax (CA); Dmitry Trukhachev, Bedford (CA); Monirosharieh Vameghestahbanati, Kanata (CA); Alireza Bayesteh, Brossard (CA)

(21) Appl. No.: 19/330,476

(22) Filed: Sep. 16, 2025

Related U.S. Application Data
(63) Continuation of application No. PCT/CA2023/050372, filed on Mar. 22, 2023.

(51) Int. Cl. H04W 74/0833; H04L 1/00; H04W 64/00

(52) U.S. Cl. CPC H04W 74/0833; H04L 1/0061; H04W 64/00

(57) ABSTRACT

Receiving first mapping information for a plurality of pools for a transmission feature, each of the plurality of pools defining a set of possible values for the transmission feature, the first mapping information associating a location indicator of the apparatus with a particular pool in the plurality of pools; and transmitting, to a network device, a random access message according to a particular value of the transmission feature, wherein the particular value is selected from a particular set of possible values defined by the particular pool, wherein the particular pool is selected from the plurality of pools based on the first mapping information and the location indicator of the apparatus.

### CROSS-REFERENCE TO RELATED APPLICATION

This application is a continuation of International Application No. PCT/CA2023/050372, filed on Mar. 22, 2023, which is hereby incorporated by reference in its entirety.

### TECHNICAL FIELD

The present application relates to communication networks and, in particular, to the transmission and reception of random access messages in communication networks.

### BACKGROUND

In grant-based access, electronic devices obtain a resource allocation (e.g. a grant) from a base station and transmit a message to the base station using the allocated resources. In grant-free random access, electronic devices may transmit messages to the base station on demand, without grant-based allocation of transmission resources.

An example of grant-free random access used in Fifth Generation (5G) New Radio (NR) Releases 16 and 17 is 2-step random access channel (RACH). In 2-step RACH, the preamble part of a packet to be transmitted by an electronic device depends on an identifier (ID) associated with the electronic device. The preamble is followed by a payload in which data (e.g. user information) is encoded. However, 2-step random access might not be suitable for massive communications, in which a base station serves a large number of electronic devices, because the preambles depend on the IDs associated with the electronic devices. In general, any access technique in which preamble and/or payload encoding depends on a pre-allocated device identifier may not be suitable for massive access with a large pool of potential devices. In addition, the data transmitted by an electronic device is often more important than its identifier. As such, using resources for transmitting preambles based on device identifiers is potentially wasteful for the transmitter and the receiver.

Unsourced random access (URA), introduced in “A perspective on massive random-access”, Y. Polyanskiy, IEEE International Symposium on Information Theory-Proceedings, pp. 2523-2527 August 2017, doi: 10.1109/ISIT.2017.8006984, is a new paradigm in random access communications. In URA, packets to be transmitted by an electronic device may be encoded in a way that the receiver can detect and decode them without using pre-assigned unique device identifiers. This makes URA a better candidate for massive connectivity in 6G. In a URA system, the base station focuses on decoding and recovering the content of received messages without using permanently assigned device identifiers. URA has many applications, such as sensor networks, Machine to Machine (M2M) communication, and the Internet of Things (IoT). In order to increase the number of supported users, MIMO and massive MIMO can naturally complement URA by providing antenna diversity and signal combining.

However, existing approaches for URA are insufficient for supporting very large (e.g. massive) numbers of devices.

### SUMMARY

According to aspects of the present disclosure, a transmission feature of a random access message transmitted by an apparatus towards a network node is based on a location indicator of the apparatus. More specifically, a pool of possible values of the transmission feature is selected based on the location identifier of the apparatus, and the value of the transmission feature is selected from the pool of possible values.

By basing the value of the transmission feature of the random access message on the location identifier of the apparatus (e.g. of the transmission device), a network device receiving the random access message may distinguish between messages received from different apparatus based on the location of the apparatus. In addition to providing an opportunity to resolve collisions, this reduces the number of possible values that need to be included in each pool (e.g. reduces pool size), which reduces complexity and thereby reduces memory requirements. By reducing the pool size and complexity, more apparatus may be supported at a higher power efficiency with a lower per-user (e.g. per-device) probability error. In examples in which the transmission feature relates to the preamble of the random access message, basing the value of the transmission feature on the apparatus's location identifier allows for using smaller (shorter) preambles, thereby allowing for longer payloads.

In an aspect, a method performed by an apparatus is provided. The method involves receiving first mapping information for a plurality of pools for a transmission feature. Each of the plurality of pools defines a set of possible values for the transmission feature. The first mapping information associates a location indicator of the apparatus with a particular pool in the plurality of pools. The method also involves transmitting, to a network device, a random access message according to a particular value of the transmission feature. The particular value is selected from a particular set of possible values defined by the particular pool. The particular pool is selected from the plurality of pools based on the first mapping information and the location indicator of the apparatus.

The transmission feature may include one or more of: a random access preamble, a signature and permutation sequence for payload encoding, a modulation scheme, and a forward error correction code for encoding.

The location indicator of the apparatus may include one or more of: a range of the apparatus with respect to the network device, an angle of arrival at the network device from the apparatus, and a coverage enhancement level of the apparatus.

The method may also involve receiving second mapping information associating a geographical location of the apparatus with the location indicator of the apparatus. The location indicator of the apparatus may be determined based on the second mapping information and the geographical location of the apparatus.

The first mapping information may associate at least two different regions with a same pool in the plurality of pools. The first mapping information may associate two adjacent regions with different pools in the plurality of pools.

The first mapping information may be received from the network device.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of the apparatus, cause the apparatus to perform the method above. In another aspect, the memory may be provided (e.g. separate to the apparatus).

In another aspect, a method performed by a network device is provided. The method involves transmitting, to an apparatus, first mapping information for a plurality of pools for a transmission feature. Each of the plurality of pools defines a set of possible values for the transmission feature. The first mapping information associates a location indicator of the apparatus with a particular pool in the plurality of pools. The method also involves receiving a random access message transmitted, by the apparatus, according to a particular value of the transmission feature. The particular value is selected from a particular set of possible values defined by the particular pool, wherein the particular pool is selected from the plurality of pools based on the first mapping information and the location indicator of the apparatus.

The transmission feature may include one or more of: a random access preamble, a signature and permutation sequence for payload encoding, a modulation scheme, and a forward error correction code for encoding.

The location indicator of the apparatus may include one or more of: a range of the apparatus with respect to the network device, an angle of arrival at the network device from the apparatus, and a coverage enhancement level of the apparatus.

The method may involve transmitting, to the apparatus, second mapping information associating a geographical location of the apparatus with the location indicator of the apparatus.

The first mapping information may associate at least two different regions with a same pool in the plurality of pools. The first mapping information may associate two adjacent regions with different pools in the plurality of pools.

The method may also involve, for a pool in the plurality of pools, in which the pool defining a particular set of possible values for the transmission feature, determining the set of possible values defined by the pool based on a number of active apparatus in a region associated with the pool. Determining the set of possible values for the transmission feature based on the number of active apparatus in the region associated with the pool may involve determining a quantity of values to be included in the plurality of possible values defined by the pool based on the number of active apparatus in the region associated with the pool.

In a further aspect, a network device configured to perform the above-mentioned method is also provided. The network device may include a processor and a memory (e.g. a non-transitory processor-readable medium). The memory stores instructions (e.g. processor-readable instructions) which, when executed by a processor of the network device, cause the network device to perform the method above. In another aspect, the memory may be provided (e.g. separate to the network device).

In another aspect, an apparatus is provided. The apparatus includes a processor and a memory. The memory stores instructions which, when executed by the processor, cause the apparatus to receive first mapping information for a plurality of pools for a transmission feature and transmit, to a network device, a random access message according to a particular value of the transmission feature.

Each of the plurality of pools defines a set of possible values for the transmission feature. The first mapping information associates a location indicator of the apparatus with a particular pool in the plurality of pools. The particular value is selected from a particular set of possible values defined by the particular pool, in which the particular pool is selected from the plurality of pools based on the first mapping information and the location indicator of the apparatus.

The transmission feature may include one or more of: a random access preamble, a signature and permutation sequence for payload encoding, a modulation scheme, and a forward error correction code for encoding.

The location indicator of the apparatus includes one or more of: a range of the apparatus with respect to the network device, an angle of arrival at the network device from the apparatus, and a coverage enhancement level of the apparatus.

The apparatus may be further caused to receive second mapping information associating a geographical location of the apparatus with the location indicator of the apparatus. The location indicator of the apparatus may be determined based on the second mapping information and the geographical location of the apparatus.

The first mapping information may associate at least two different regions with a same pool in the plurality of pools. The first mapping information may associate two adjacent regions with different pools in the plurality of pools.

The first mapping information may be received from the network device.

In another aspect, a network device is provided. The network device includes a processor and a memory. The memory stores instructions which, when executed by the processor, cause the network device to transmit, to an apparatus, first mapping information for a plurality of pools for a transmission feature, and receive a random access message transmitted, by the apparatus, according to a particular value of the transmission feature.

Each of the plurality of pools defines a set of possible values for the transmission feature. The first mapping information associates a location indicator of the apparatus with a particular pool in the plurality of pools. The particular value is selected from a particular set of possible values defined by the particular pool, in which the particular pool is selected from the plurality of pools based on the first mapping information and the location indicator of the apparatus.

The transmission feature may include one or more of: a random access preamble, a signature and permutation sequence for payload encoding, a modulation scheme, and a forward error correction code for encoding.

The location indicator of the apparatus may include one or more of: a range of the apparatus with respect to the network device, an angle of arrival at the network device from the apparatus, and a coverage enhancement level of the apparatus.

The network device may be further caused to transmit, to the apparatus, second mapping information associating a geographical location of the apparatus with the location indicator of the apparatus.

The first mapping information may associate at least two different regions with a same pool in the plurality of pools. The first mapping information may associate two adjacent regions with different pools in the plurality of pools.

The network device may be further caused to, for a pool in the plurality of pools, the pool defining a particular set of possible values for the transmission feature, determine the set of possible values defined by the pool based on a number of active apparatus in a region associated with the pool.

The network device may be caused to determine the set of possible values for the transmission feature based on the number of active apparatus in the region associated with the pool by determining a quantity of values to be included in the plurality of possible values defined by the pool based on the number of active apparatus in the region associated with the pool.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 shows a system according to embodiments of the disclosure.

FIG. 6 shows a signaling diagram for a method performed by the network device and a first apparatus according to embodiments of the disclosure.

FIG. 7 shows an example implementation of the first apparatus according to embodiments of the disclosure.

FIG. 8 shows an example implementation of the network device according to embodiments of the disclosure.

FIG. 9 shows the division of space around a network device into regions according to embodiments of the disclosure.

FIGS. 10 and 11 show flowcharts of methods according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

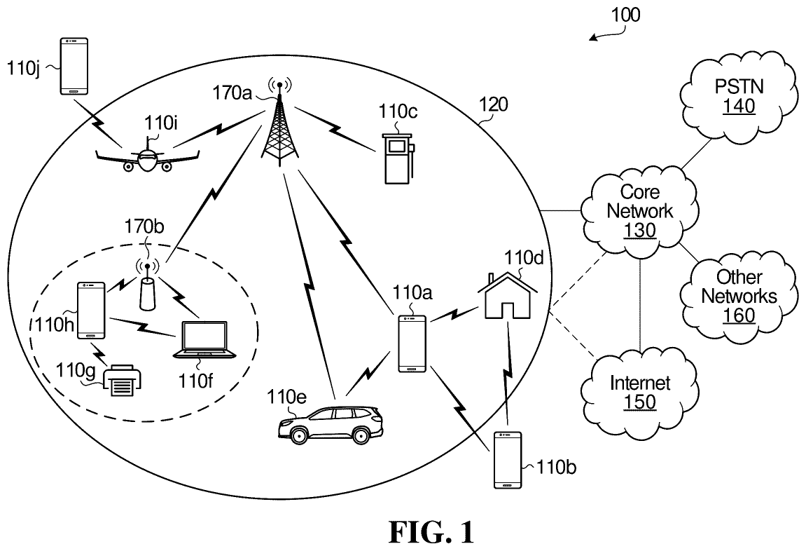

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

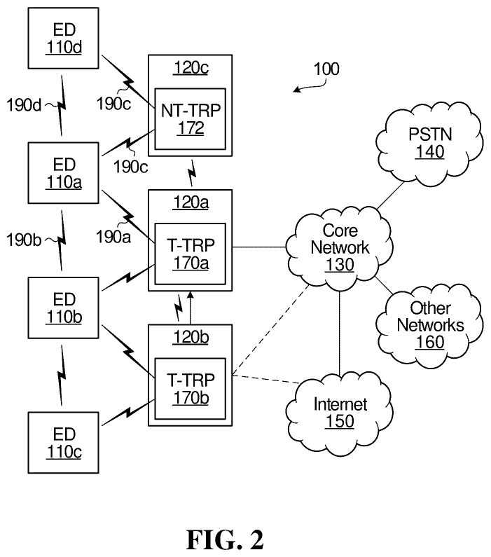

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

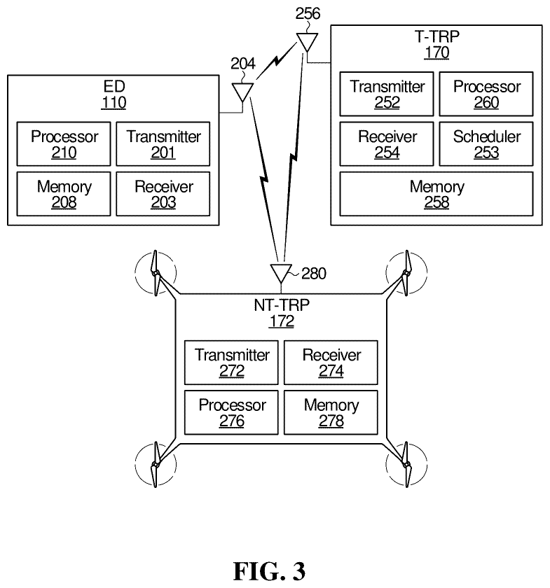

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

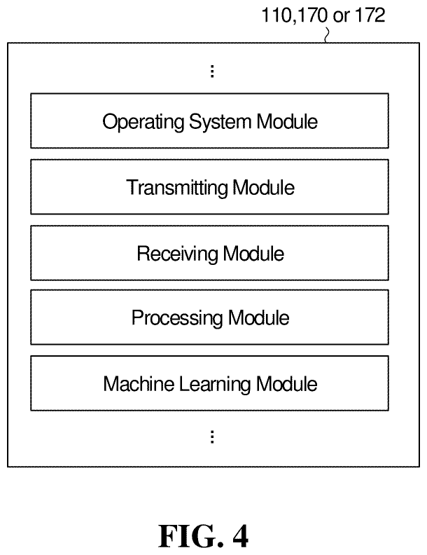

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A sensing system may be used to help gather pose information for a particular object, such as an apparatus. Pose information may include, for example, one or more of: a relative location of the particular object (e.g. with respect to a reference point or other apparatus), location in a global coordinate system, movement of the object (relative or in a global coordinate system), orientation information and the information about the wireless environment. “Location” is also known as “position” and these two terms may be used interchangeably herein. The relative location of the object may include a distance to the object and/or a direction to the object. The movement of the object may include a speed, direction of movement and/or acceleration of the object, for example.

Sensing systems may be particularly useful for obtaining pose information for electronic devices, which may be referred to as electronic device pose information. Electronic device pose information may be used in cellular communication networks to improve various performance metrics for the network. Such performance metrics may, for example, include capacity, agility and/or efficiency. The improvement may be achieved when elements of the network exploit the position, the behavior, the mobility pattern, etc. of the electronic device in the context of a priori information describing a wireless environment in which the electronic device is operating.

Examples of well-known sensing systems include RADAR (Radio Detection and Ranging) and LIDAR (Light Detection and Ranging). While the sensing system is typically separate from the communication system, it could be advantageous to gather the information using an integrated system to reduce the hardware (and cost) in the system as well as the time, frequency or spatial resources needed to perform both functionalities. However, using the communication system hardware to perform sensing of electronic device pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Direct Fourier Transform spread OFDM (DFT-OFDM), Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; cognitive radio-based access; power domain multiplexing (also referred to as power division multiple access); spreading codes; signatures and hopping sequences.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target. A non-exhaustive list of possible unit or possible configurable parameters or in some embodiments of a MIMO system include: a panel; and a beam. A beam may be formed by performing amplitude and/or phase weighting on data transmitted or received by at least one antenna port. A beam may be constructed in analog (RF) domain by phase shifters, in digital domain (baseband) through precoding or in a hybrid analog/digital domain. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or an SRS resource identifier, or other reference signal resource identifier.

### Unsourced Random Access

Unsourced random access (URA) schemes are grant-free random access schemes which do not depend on device identifiers. That is, the receiver may receive and decode random access messages without using device identifiers. The performance of URA is usually evaluated using the Per User Probability of Error (PUPE). Typical URA systems achieve a PUPE of 1-10%. This is different to traditional multiple access, which targets nearly error-free communication conditions for each device.

Several Multiple-Input Multiple-Output (MIMO) URA systems have been proposed. Example MIMO URA systems include tensor-based packet construction, sub-block Compressed Sensing (CS) coded URA, and the preamble-payload URA.

In tensor-based MIMO URA, electronic devices use rank-1 tensors to construct their messages. The signals from an individual electronic device may be detected in a combined received signal by applying a rank-Kₐ tensor decomposition, in which Kₐ is the number of active electronic devices. Employing tensors thus alleviates the need to send pilot signals for channel estimation and allows for separating messages from different electronic devices without using other multiple user detection techniques.

Although tensor-based MIMO URA eliminates the need to transmit pilot signals for channel estimation, this design only supported a limited number of active devices. Transmissions from different devices are only separable when the number of devices is lower than the expected generic rank of the set of tensors. In addition, tensor-based MIMO URA uses a rank-Kₐ tensor decomposition to separate signals transmitted by different devices under the assumption that the channels of the different devices are independent and identically distributed (i.i.d). In reality, channels are often correlated, which reduces the rank of the channel matrix and thus the number of devices that can be supported using tensor-based MIMO URA. Therefore, tensor-based MIMO URA might not be suitable for massive communication. In addition, tensor-based MIMO URA is less energy efficient than some other approaches. Further details regarding tensor-based MIMO URA may be found in “Tensor-Based Modulation for Unsourced Massive Random Access”, A. Decurninge et al., IEEE Wireless Communications Letters, vol. 10, no. 3, pp. 552-556, March 2021, doi: 10.1109/LWC.2020.3037523.

Two examples of sub-block CS-coded URA are described in “Coded Compressed Sensing with Successive Cancellation List Decoding for Unsourced Random Access with Massive MIMO”, V. K. Amalladinne et al., May 2021, doi: 10.48550/arxiv.2105.02185 (Amalladinne) and “Massive Unsourced Random Access: Exploiting Angular Domain Sparsity”, X. Xie et al., IEEE Transactions on Communications, vol. 70, no. 4, pp. 2480-2498 April 2022, doi: 10.1109/TCOMM.2022.3153957 (Xie).

In Amalladinne, each device splits its message into a few subblocks. Each sub-block is encoded via a compressed sensing method in which the sensing matrix is known at both the transmitter and receiver. A non-Bayesian covariance-based activity detection algorithm is used at the receiver to recover these subblocks. To concatenate the subblocks of a message from a particular device, an outer tree error-correction code is used. A successive cancellation list decoding algorithm allows the inner and outer decoders to work together.

The method outlined in Amalladinne has relatively good error performance when supporting a low number of active users, and is less complex than some other approaches. However, the issue of collision resolution, e.g. distinguishing between two packets encoded in the same way but transmitted simultaneously by different devices, remains outstanding in Amalladinne. In addition, the use of a tree code results in a rate loss that lowers the resulting transmission rate and spectral efficiency. The method outlined in Amalladinne also supports fewer active devices than the preamble-payload approaches discussed in more detail below.

Although Xie uses the same packet structure as Amalladinne, Xie proposes a particular reception technique that relies on sparse patterns of individual device channels for distinguishing between devices and performing collision resolution at the receiver. Xie uses generalized approximate message passing (GAMP) for sparse signal reconstruction. To estimate the channel parameters, an expectation-maximization method is employed. Complete messages are obtained by stitching together the subblocks of each device at the receiver using a clustering algorithm. In this way, Xie addresses many of the shortcomings of Amalladinne and supports a higher number of active devices compared to Amalladinne. However, the design proposed in Xie is not energy efficient. In addition, it relies on devices' channels being sparse in the angular domain.

Two examples of preamble-payload URA are described in “Spread Unsourced Random Access With an Iterative MIMO Receiver”, E. Nassaji et al., IEEE Communications Letters, vol. 26, no. 10, pp. 2495-2499 October 2022, doi: 10.1109/LCOMM.2022.3195410 (Nassaji) and “Pilot-Based Unsourced Random Access with a Massive MIMO Receiver, Interference Cancellation, and Power Control”, A. Fengler et al., IEEE Journal on Selected Areas in Communications, vol. 40, no. 5, pp. 1522-1534 May 2022, doi: 10.1109/.JSAC.2022.3144748 (Fengler).

The approaches described in Nassaji and Fengler rely on splitting each device's message into two parts: a shorter CS-encoded preamble and a longer payload encoded for error correction and modulated to cater for multiple user detection (MUD) at the receiver. During the CS encoding, the preamble is selected randomly (e.g. based on the first few bits of the data to be sent) from a pool. The pool contains many more preambles than the number of active devices to avoid collisions (e.g. to avoid two or more devices transmitting the same preamble). In Nassaji, a specific signature-permutation pair is selected from a pool of signatures and permutation sequences based on an index of the chosen preamble. The signature and permutation are then used to encode the payload.

At the receiver side, a Multi Measurement Vector-Approximate Message Passing (MMV-AMP) algorithm is used to decode the CS encoding and recover the set of the active preambles used by the active devices in the transmitted messages. As a by-product, the algorithm also estimates the channels of the active devices, as well as the respective signature and permutations used for payload encoding. Indices of the signature and permutations, together with the channel estimates, are transferred to the MUD payload receiver. In Nassaji, the payload is decoded by applying an iterative MUD algorithm that involves interference cancellation, data estimation, and channel estimation refinement. In Fengler, the payload is decoded by performing Maximum Ratio Combining (MRC) followed by forward error correction (FEC) decoding.

The preamble-payload approaches described in Nassaji and Fengler are most promising in terms of the supported number of active devices, energy efficiency, and PUPE. However, to avoid collisions, a huge preamble pool is needed. This, in turn, necessitates long preambles for the CS decoder to work, resulting in increased complexity of preamble decoding and a shorter payload. Shorter payloads degrades MUD performance and limit the number of active devices that can be supported.

Although URA can support more active devices compared to existing approaches to grant-free random access, existing approaches to URA still lack the ability to support the very high number of active devices that are involved in massive communications. As described above, tensor-based approaches are limited by the rank of the tensors, sub-block designs are limited by the pool of CS sequences for the sub-bocks as well as the rate loss due to the tree code, and preamble-payload approaches are limited by the size of the preamble pool and the preamble length it necessitates to avoid user collisions. As such, existing approaches for random access are insufficient to support massive connectivity (e.g. in device-crowded applications).

According to aspects of the present disclosure, a value of a transmission feature of a random access message transmitted by an apparatus is based on a location identifier of the apparatus. In particular, the value of the transmission feature is selected from a pool of possible values, in which the pool is selected based on the location identifier of the apparatus.

By basing the value of the transmission feature of the random access message on the location identifier of the apparatus, a network device receiving the random access message may distinguish between messages received from different apparatus based on both the values of the transmission feature and the locations of the apparatus. In addition to providing an opportunity to resolve collisions, this reduces the number of possible values that need to be included in each pool (e.g. reduces pool size), which reduces complexity and thereby reduces memory requirements. By reducing the pool size and complexity, more apparatus may be supported at a higher power efficiency with a lower per user probability error. In examples in which the transmission feature relates to the preamble of the random access message, basing the value of the transmission feature on the apparatus's location identifier allows for using smaller (shorter) preambles, thereby allowing for longer payloads.

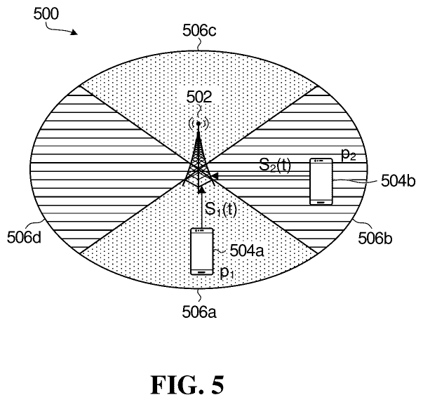

FIG. 5 shows a system 500 according to embodiments of the disclosure. The system 500 includes a network device 502, a first apparatus 504a and a second apparatus 504b.

The network device 502 may be a TRP (e.g. may be a network node or base station), such as any of the TRPs 170 described above in respect of FIGS. 1-4. In some examples, the network device 502 may have (e.g. comprise or otherwise be connected to) two or more antennas. The network device 502 may, for example, be a MIMO base station (e.g. an example of a MIMO system).

The first apparatus 504a may, for example, be an electronic device, such as any of the electronic devices 110 described above in respect of FIGS. 1-4. The second apparatus 504b may be an electronic device, such as any of the electronic devices 110 described above in respect of FIGS. 1-4. The first and second apparatus 504a, 504b may be the same type of electronic device (e.g. the first and second apparatus 504a, 504b may be smartphones) or different types of electronic device (e.g. the first apparatus 504a may be a smartphone and the second apparatus 504b may be a car). The system 500 may comprise a radio access network, such as the radio access network 120, for example.

The vicinity (e.g. the space or area around the network device 502) is divided into first, second, third and fourth regions 506a, 506b, 506c, 506d (506 collectively). The regions may be geographical. That is, the regions may be a contiguous area or volume of space. The regions may be based on a location indicator, such as angle of arrival, range or coverage enhancement level. That is, each region may correspond to a region of space in which a location indicator has a particular value or range of values. For example, each of the regions 506 may correspond to a particular range of values of angle of arrival. The regions may alternatively be referred to as sectors, areas, subregions (e.g. indicating that together they form a larger region) etc. In this example, there are four regions 506 of equal size. In general, there may be two or more regions, in which the two or more regions have the same size (e.g. the same dimensions and/or volume) or different sizes.

As illustrated in FIG. 5, the first apparatus 504a is located in the first region 504a and the apparatus 504b is located in the second regions 504b. In general, there may be more or fewer apparatus. For example, there may be two or more apparatus, in which each apparatus is in one of the regions 506.

According to aspects of the present disclosure, the first and second apparatus 504a, 504b may transmit random access messages to the network device 502 in accordance with values of a transmission feature that are associated with an indicator of their location. This allows the network device 502 to identify which values of the transmission feature have been used based on the location of the first and second apparatus 504a, 504b and the respective channel matrices. It also allows the network device 502 to distinguish between a random access message received from the first apparatus 504a and a random access message from the second apparatus 504b, even if they are transmitted and/or received at the same time.

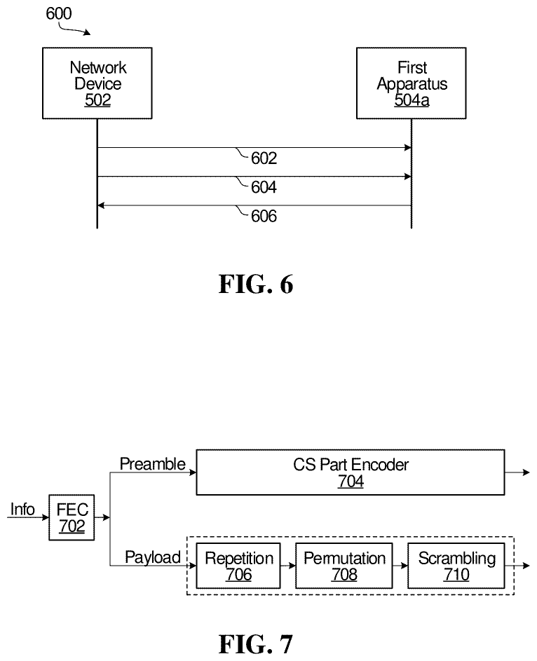

This is described in more detail in respect of FIG. 6, which shows a signaling diagram for a method 600 performed by the network device 502 and the first apparatus 504a. Although this method 600 is described with respect to the first apparatus 504a, it will be appreciated that the method may be performed in respect of the second apparatus 504b (e.g. at the same time or a different time as the method is performed in respect of the first apparatus 504a) or any other apparatus in the system 500.

In step 602, the network device 502 transmits, to the first apparatus 504a, first mapping information for a plurality of pools for a transmission feature.

The transmission feature may be a property of a random access message to be sent by the first apparatus 504a. The transmission feature may affect the contents of the random access message to be transmitted by the first apparatus 504a. For example, the transmission feature may be a random access preamble to be included in the random access message. As another example, the transmission feature may affect the way in which the random access message is transmitted by the first apparatus 504a. For example, the transmission feature may be a modulation scheme to be used for transmission of the random access message. It will be appreciated that there are various types of transmission features which may be used such as, for example, a random access preamble (e.g. an unsourced random access preamble, referred to as a URA preamble), a signature and permutation sequence (e.g. for preamble or payload encoding), a modulation scheme and a forward error correction (FEC) code (e.g. for encoding some or all of the random access message). In general, the transmission feature can be a characteristic or property of the random access message that facilitates separation of random access messages transmitted simultaneously by multiple apparatus by the network device 502 using signal processing (e.g. independently of the location of the apparatus).

The URA preamble may be a sequence of complex numbers. In general, a URA preamble may comprise the first part of a URA message. It may be used to inform an apparatus that receives a URA message of the contents of the URA message e.g. that the received message or packet comprises the particular URA preamble and/or a payload associated with the particular URA preamble. The correct recovery of all URA preambles by an apparatus receiving multiple URA preambles may allows the apparatus to determine how many packets have been received and how to recover the packet payloads.

In this context, a signature may be a sequence for scrambling data symbols in a payload. That is, payload symbols may be multiplied symbol-by-symbol with a particular signature sequence. An example signature sequence is −1, 1, −1, 1.

In this context, a permutation may be a sequence indicating the way in which data symbols in a payload maybe reordered in the process of payload encoding. For example, the permutation (2, 3, 1) may indicate that, after reordering, the second symbol should appear first, the third symbol should appear second, and the first symbol should appear third.

The first mapping information associates a location indicator of the first apparatus 504a with a particular pool in the plurality of pools.

Each of the plurality of pools defines a set of possible values for the transmission feature. For example, a first pool in the plurality of pools may define a first set of code rates for an FEC code and a second pool in the plurality of pools may define a second set of code rates for the FEC code. In another example, a first pool in the plurality of pools may define a set of types of FEC code and a second pool in the plurality of pools may define a second set of types for the FEC code. The types of code may be any suitable type of FEC code such as, for example, turbo, low density parity check (LDPC), convolutional, Reed Solomon (RS), Bose-Chaudhuri-Hocquenghem (BCH) and polar codes.

In some examples, each pool in the plurality of pools may be mutually exclusive with every other pool in the plurality of pools. That is, there may be no overlap between different pools. In other examples, the pools may overlap (e.g. a particular value of the transmission feature may be present in multiple pools).

In some examples, each pool may define a set of possible values for the transmission feature that are orthogonal or semi-orthogonal to one another. For example, a pool may define a set of possible preambles, in which each preamble in the pool is orthogonal to each other preamble in the pool. An example of a preamble pool that contains orthogonal preambles is a pool defining the following four preambles: −1 1 1 −1, −1 −1 1 1, 1 1 −1 −1 and −1 1 1 −1. These may be referred to as Hadamard sequences.

The first mapping information may include the set of possible values for the transmission feature. That is, the network device 502 may, in step 602, transmit the possible values for the transmission feature for each pool to the first apparatus 504a. Alternatively, the first mapping information may indicate the set of possible values for each pool without explicitly sending the sets of possible values. For example, the first mapping information may specify a minimum and a maximum value of the transmission feature (e.g. a minimum and a maximum code rate) for each pool. As a further alternative, the first mapping information may associate an identifier for each pool to a respective location indicator. The set of possible values defined by a pool identified by a particular identifier may be stored at the first apparatus 504a (e.g. to enable the first apparatus 504a to determine the set of possible values defined by a pool based on its respective identifier). Alternatively, the network device 502 may send the identifiers for the pools and indications of the sets of possible values defined by the pools in a different message to the first mapping information.

The location indicator may be indicative of a relative location of the first apparatus 504a with respect to the network device 502. The location indicator may be a geographical feature that relates to transmissions from the apparatus 504a to the network device 502. The location indicator may, for example, comprise (e.g. be based on) one or more of: a range of the first apparatus 504a with respect to the network device 502 (e.g. a distance between the first apparatus 504a and the network device 502), an angle of arrival at the network device 502 from the first apparatus 504a (e.g. for transmissions from the first apparatus 504a to the network device 502), a coverage enhancement level of the first apparatus, altitude, a density of neighbouring apparatus etc. The coverage enhancement level may alternatively be referred to as a coverage enhancement mode. The coverage enhancement level may indicate a number of times messages transmitted between the network device 502 and the first apparatus 504a are to be repeated. In some examples, there may be up to three possible coverage enhancement levels. For example, the first apparatus 504a may have a coverage enhancement level of 0, 1 or 2. In general, the location indicator may be a value that facilitates separation of random access messages transmitted simultaneously from multiple apparatus by the network device 502 by signal processing.

In step 604, the network device 502 transmits second mapping information to the first apparatus 504a. The second mapping information associates the location indicator of the first apparatus 504a with a geographical location of the first apparatus 504a. The association may be direct. For example, the second mapping information may associate the range of the first apparatus 504a with the coordinates of the first apparatus 504a (e.g. in a geographical coordinate system). Alternatively, the association may be indirect. That is, the second mapping information may associate the location indicator of the first apparatus 504a with a measure that indirectly indicates the geographical location of the first apparatus 504a. For example, the second mapping information may associate the location indicator (e.g. a coverage enhancement level) with a Received Signal Received Power (RSRP) of signals received at the first apparatus 504a from the network device 502. As the RSRP is affected by the range between the first apparatus 504a and the network device 502, it may be indicative of the geographical location of the first apparatus 504a.

The network device 502 may transmit the second mapping information to the first apparatus 504a in the same message or a different message to the first mapping information. The second mapping information may be transmitted to the first apparatus 504a before, after or at the same time as the first mapping information.

The first and/or second mapping information may be provided in any suitable form. In some examples, the first and/or second mapping information may comprise a look-up table (LUT). For example, the first mapping information may comprise a table comprising ranges of values for the location indicator and, for each range of values, an indication of the respective pool in the plurality of pools. The indication for a particular pool may comprise an identifier for that pool. In another example, the second mapping information may comprise a table comprising, in a first column, ranges of values for the RSRP for signals received by the first apparatus 504a from the network device 502 and, in a second column, indications of the coverage enhancement levels (an example of a location indicator) corresponding to the RSRP values. Alternatively, the indication may comprise the set of possible values for the transmission feature defined by that pool.

In other examples, the first and/or second mapping information may comprise a formula. For example, the first mapping information may comprise a formula which may be used to determine, for a particular location indicator, the set of possible values for the transmission feature for its respective pool. It will be appreciated that the first and/or second mapping information may take other forms. For example, the first and/or second mapping information may comprise a dictionary. In another example, the second mapping information may comprise the coordinates of the network device 502, enabling the range (an example of a location indicator) of the first apparatus 504a to be determined based on the coordinates of the first apparatus 504a (e.g. as determined by a Global Navigation Satellite System sensor at the first apparatus 504a) and the second mapping information.

In yet further examples, the first mapping information may comprise an indicator that indicates an association between the location indicator of the first apparatus 504a and a particular pool in the plurality of pools. For example, a plurality of potential mappings between the location indicator and a particular pool may be stored at the first apparatus 504a, and the first mapping information may comprise an indicator that identifies a particular mapping in the plurality of potential mappings stored at the first apparatus 504a. Similarly, the second mapping information may comprise an indicator that indicates an association between the location indicator of the first apparatus 504a and a geographical location of the first apparatus 504a.

The first mapping information and/or the second mapping information may be transmitted to the first apparatus 504a using semi-static signaling. For example, the network device 502 may transmit the first mapping information and/or the second mapping information to the first apparatus 504a using Radio Resource Control (RRC) signaling (e.g. in an RRC message). In general, the first mapping information and/or the second mapping information may be transmitted to the first apparatus 504a using any suitable signaling.

In step 606, the first apparatus 504a transmits a random access message to the network device 502.

The random access message may comprise a random access preamble (e.g. a URA preamble). For example, the random access message may comprise a Msg1. The random access message may or might not include data (e.g. a payload). The data may be in addition to the random access preamble. For example, the random access message may form part of a two-step random access procedure in which the first apparatus 504a transmits the random access message including a random access preamble and data. The random access message may comprise a MsgA.

The random access message may be an unsourced random access message. The method 600 may be or form a part of an unsourced random access procedure. That is, the random access message might not be based on an identifier (e.g. an identity) of the first apparatus 504a. As the network device 502 might not need to know and/or use the identifier of the first apparatus 504a, not basing the random access message on the identifier of the first apparatus 504a can free up resources for more useful information. This allows for using network resources more efficiently. Not basing the random access message on the identifier may also reduce complexity when the number of active apparatus is large.

The first apparatus 504a transmits the random access message to the network device 502 according to a particular value of the transmission feature. The determination of the particular value of the transmission feature may be summarised as follows. The first apparatus 504a determines its location indicator based on its geographical location and the second mapping information. The first apparatus 504a selects a particular pool from the plurality of pools based on the location indicator and the first mapping information. The first apparatus 504a selects the particular value of the transmission feature from the particular pool.

The first apparatus 504a may obtain its geographical location in any suitable way, such as from a global navigation satellite system (GNSS) sensor comprised in or otherwise connected to the first apparatus 504a. Thus, for example, the first apparatus 504a may obtain coordinates of its location (e.g. in a geographic coordinate system) from its GNSS and determine, based on the coordinates and the second mapping information, the range between the first apparatus 504a and the network device 502. The first apparatus 504a may, additionally or alternatively, obtain its geographical location using sensing. The first apparatus 504a may, for example, implement a sensing system such as any of the sensing systems described above.

As mentioned above, the first mapping information associates different values of the location indicator with particular pools in the plurality of pools. The first apparatus 504a thus selects the particular pool that corresponds to its location indicator based on the first mapping information.

Selecting the particular value of the transmission feature from the particular pool involves determining the particular value based on the set of possible values for the transmission feature defined by the particular pool. For example, the particular pool may define a minimum and a maximum code rate and the first apparatus 504a may select (e.g. at random) a particular value of the code rate that is between the minimum and maximum values. In another example, the particular pool may define a list of potential FEC codes that may be used. The first apparatus 504a may select one of the FEC codes (e.g. a particular type of FEC code) from the list. The first apparatus 504a may select the particular value of the transmission feature from the particular pool at random.

The network device 502 thus receives the random access message that has been transmitted by the first apparatus 504a in accordance with the particular value of the transmission feature based on the location indicator of the first apparatus 504a. For example, some or all of the random access message (e.g. a preamble and/or payload included in the random access message) may have been encoded with an FEC code selected from a pool that the first mapping information maps to the location indicator of the first apparatus.

The network device 502 may, based on the particular value of the transmission feature, distinguish the random access message transmitted by the first apparatus 504a in step 606 from a random access message transmitted by another apparatus, such as the second apparatus 504b. Thus, the particular value of the transmission feature may aide in detection of the random access message by the network device 502. For example, the network device 502 may distinguish the random access message transmitted by the first apparatus 504a in step 606 from a random access message transmitted by another apparatus based on a preamble included in the random access message, in which the preamble is selected from a pool of potential preambles that is associated, according to the first mapping information, with the location indicator of the first apparatus 504a.

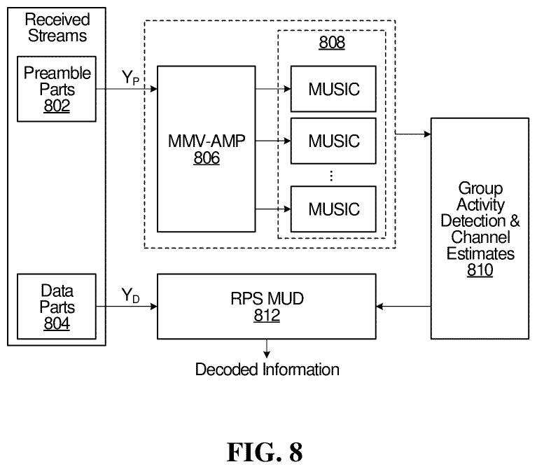

The network device 502 may also estimate the location indicator of the first apparatus 504a (e.g. based on the random access message transmitted in step 606). The network device 502 may use the estimate of the location indicator, together with the first mapping information, to distinguish the random access message transmitted by the first apparatus 504a in step 606 from a random access message transmitted by another apparatus. An example implementation of this is described in more detail below in respect of FIG. 8.

### ASSOCIATION BETWEEN POOLS AND LOCATION

As described above, the particular pool for the first apparatus 504a is selected based on the location indicator of the first apparatus 504a. It will be appreciated that, although the pool is selected based on the location indicator, the pools may be more generally associated with location. Thus, for example, each of the regions 506a, 506b, 506c, 506d may be associated with a respective pool in the plurality of pools. More generally, in some examples, two or more regions (e.g. proximate to the network device 502) may be associated with respective pools in the plurality of pools. In some examples, each region may be uniquely associated with a different pool and vice-versa. That is, there may be a one-to-one mapping between pools and regions such that no pool is re-used. This may be advantageous, particularly when there is no overlap between pools, because it may reduce the risk of collisions between transmissions. In other examples, the same pool may be used for two different regions. Reusing pools reduces the overall number of values of the transmission feature that need to be available, which can reduce complexity. In examples in which the transmission feature comprises a random access preamble, reusing pools can reduce the overall number of preambles available for use and hence the preamble length. Using shorter preambles allows for longer payloads, which allows for carrying more data in each message. Using shorter preambles also allows for receiving messages from more apparatus with more robust multi-user detection.

In some examples, adjacent regions may be associated with different pools (e.g. with different pools that do not overlap with one another). This is illustrated by the different hatchings of the regions 506 shown in FIG. 5. The first and third regions 506a, 506c are associated with a first pool and the second and fourth regions 506b, 506d are associated with a second pool, in which the first and second pool are different. Associating adjacent regions with different pools reduces the risk of collision. More specifically, it provides the opportunity for the network device 502 to verify that received packets (e.g. the random access message transmitted in step 606) are detected and decoded correctly by comparing the pool associated with a detected value of the transmission feature (e.g. detected preamble-signature-permutation's pool) with the detected location indicator (e.g. the detected Angle of Arrival). It also reduces the probability that two closely located apparatus select the same value of the transmission feature. Closely located apparatus users may have correlated channels (e.g. in terms of the location indicator, such as angle of arrival), which means that distinguishing between closely located apparatus can be challenging for the network device 502. Therefore, associating adjacent regions with different pools can reduce the risk and impact of collision. In addition, associating adjacent regions with different pools reduces the risk of collision may allow for reusing pools for different regions (and thus reducing complexity) without adversely affecting performance.

In some examples, adjacent regions may be associated with orthogonal or semi-orthogonal pools. That is, a first pool associated with a first region may define a set of first possible values for a transmission feature and a second pool associated with a second region, adjacent to the second region may define a set of second possible values for the transmission feature, in which the first possible values for the transmission feature are orthogonal, or semi-orthogonal, to the second possible values for the transmission feature. For example, the first pool may define a set of first sequences and the second pool may define a set of second sequences, in which the first sequences are semi-orthogonal to the second sequences. To create semi-orthogonal sequences, each element of every sequence may be drawn independently from a random complex Gaussian variable with zero mean and variance 1. In another example, the first pool may define a set of first preambles and the second pool may define a set of second preambles, in which the first preambles are orthogonal to the second preambles.

### MULTIPLE APPARATUS

Although the method 600 is described above in respect of communications between the network device 502 and the first apparatus 504a, it will be appreciated that, in other embodiments, the method 600 may be performed in respect of the network device 502 and two or more apparatus. For example, if there are Kₜₒₜ potential apparatus that may become active (e.g. including the first apparatus 504a and the second apparatus 504b) and Kₐ of these apparatus are active at any time (Kₐ<<Kₜₒₜ), the space around the network device 502 may be divided into multiple regions according to a location indicator (e.g. the angle of arrival and/or the distance to the network device 502). A pool of transmission features (e.g. preambles, signature-permutation patterns, forward error-correction (FEC) codes used to encode the payload etc.) that the apparatus use to encode their packets, may be allocated to each region. An active apparatus modulates its transmitted signal (e.g. its transmitted random access message) based on the data it has to transmit and selects the transmission features from the pool corresponding to the apparatus's location.

This may be illustrated by considering an example in which the method 600 is performed in respect of the network device 502 and the first and second apparatus 504a, 504b. The location indicators of the first and second apparatus 504a, 504b may be associated with different pools as they are in different regions. The network device 502 may thus receive a first random access message transmitted by the first apparatus 504a in accordance with a first value of a transmission feature based on a first pool and a second random access message transmitted by the second apparatus 504b in accordance with a second value of the transmission feature based on a second pool. The network device 502 may distinguish between the first and second random access message based on the first and second values of the transmission feature and/or estimates of the location indicators for the first and second apparatus 504a, 504b.

For example, the first apparatus 504a and the second apparatus 504b may have location indices p₁ and p₂ (e.g. in distinct angle of arrival regions) as shown in FIG. 5. Vectors B₁ and B₂ may represent the information bit messages of the first apparatus 504a and the second apparatus 504b respectively. These messages will be encoded by the respective apparatus 504a, 504b to generate the transmit signals S₁(t) and S₂(t), at time-slot t. According to aspects of the present disclosure, S₁(t) and S₂(t) may be functions of both the information bits and the location indices p₁ and p₂ e.g. such that S₁(t)=f(B₁, p₁) and S₂(t)=f(B₂, p₂).

### SECOND MAPPING INFORMATION

In some examples, step 604 may be omitted from the method 600. That is, the network device 502 might not transmit the second mapping information to the first apparatus 504a. The method 600 may thus proceed directly from step 602 to step 606. The first apparatus 504a may receive the second mapping information from another apparatus. Alternatively, the first apparatus 504a may already be configured with the second mapping information. As yet a further alternative, the first apparatus 504a may be capable of determining the location indicator without knowledge of the second mapping information.

### POOL DESIGN AND ALLOCATION

The pools may be determined by the network device 502. Alternatively, the network device 502 may receive an indication of the pools from another apparatus. For example, the network device 502 may receive an indication of the pools from an apparatus in a core network, such as the core network 130.

The set of possible values defined by a particular pool may be determined based on the characteristics or properties of the region associated with the particular pool. The characteristics or properties of the region may include, for example, one or more of: the strength of signals received from apparatus in that region (e.g. the average, maximum or minimum signal strength), the distance of the region from the network device (e.g. the range of apparatus in the region), the number of active apparatus in the region (e.g. the approximate number), channel conditions (e.g. apparatus channel conditions) including a number of channel paths, an angular distribution of one or more channel paths and whether a line of sight (LOS) path exists, density (e.g. density of apparatus), priority for communications etc. For example, the set of possible values defined by a particular pool may be based on a number of active apparatus in the region associated with the pool. The quantity of possible values defined by the pool (e.g. the size of the pool) may be based on the number of active apparatus in the region associated with the pool, for example. Thus, for example, the pool associated with a region with more active apparatus may define more possible values of the transmission feature than another pool associated with a region with fewer active apparatus. In some examples, FEC codes may be allocated to regions based on their particular needs. For example, regions with weaker signals (e.g. lower signal strength) may be associated with pools that have stronger FEC codes.

Additionally or alternatively, the association of a particular pool to a particular region (e.g. a set of location indicators specific to the particular region) may be based on the characteristics or properties of the region (e.g. any of the characteristics or properties mentioned above). For example, pools may be assigned to particular regions based on the number of active apparatus in those regions (e.g. larger pools may be associated with regions with more active apparatus).

By using the characteristics or properties of regions to determine the possible values defined by pools and/or to assign pools to regions, the pools allocated to each region may be optimized, thereby enabling more efficient transmission and improved performance.

### Multiple Transmission Features

In the description of the method 600, each pool defines a set of possible values of a transmission feature. In general, each pool may define one or more sets of possible values of one or more transmission features. Thus, in some examples, each pool may define two or more sets of possible values of two or more transmission features. For example, each pool may define a set of possible preambles and a set of possible FEC codes.

### Application to Other Signaling Procedures

In step 606 of the method 600, the first apparatus 504a transmits a random access message to the network device 502 according to a particular value of a transmission feature selected from a particular pool in the plurality of pools, in which the pool is selected based on the location indicator and the first mapping information. This may form part of an unsourced random access procedure (e.g. the random access message might not be based on an identifier of the first apparatus 504a), for example. In other examples, the first apparatus 504a may transmit another type of message in step 606. That is, the method 600 may be applied to signaling exchanges or procedures other than random access. In general, the first apparatus 504a may, in step 606, transmit a message according to the particular value of the transmission feature. The message may be transmitted to the network device 502 (e.g. in an uplink transmission) or another apparatus such as the second apparatus 504b (e.g. in a sidelink transmission). The steps of the method 600 that are described as being performed by the first apparatus 504a may, in general, be performed by a transmitter apparatus and the steps of the method 600 that are described as being performed by the network device 502 may, in general, be performed by a receiver apparatus.

The message may be a grant-free transmission. For example, the first apparatus 504a may transmit the message (e.g. to the network device 502) in accordance with the particular value of the transmission feature without first requesting a resource grant from the first network device 502. The message may be unsourced (e.g. may not be based on an identifier of the first apparatus 504a).

### Angle of Arrival-Based Unsourced Random Access

Another example method performed by the network device 502 and the first apparatus 504a is described with reference to FIGS. 7 and 8.

In this example, the space around the network device 502 is divided into the four regions 506a, 506b, 506c, 506d based on angle of arrival. Each angle of arrival region is associated with a respective location index (e.g. a location index). That is, each location index identifies a respective range of values of the angle of arrival. The first mapping information associates each location index with a respective pool defining a set of signature and permutation sequences and a set of preambles. The pools are constructed such that neighbouring regions have distinct (e.g. orthogonal) pools of signatures and permutation sequences. The pools are reused such that the first and third regions 506a, 506c use a first pool and the second and fourth regions 506b, 506d use a second pool, in which the first and second pool are different. In other examples, neighbouring regions might not have distinct pools and/or pools might not be reused.

The network device 502 transmits first mapping information to the first apparatus 504a. The first mapping information associates the location index of the first region 506a (in which the first apparatus 504a is located) with a particular pool defining a particular set of signal and permutation sequences and a particular set of preambles. The network device 502 may transmit the first mapping information in accordance with step 602 described above. The network device 502 also transmits the particular set of signal and permutation sequences to the first apparatus 504a.

The network device 502 also transmits second mapping information to the first apparatus 504a. The second mapping information associates location with angle of arrival. The transmission of the second mapping information may be performed in accordance with step 604 described above.

The first apparatus 504a locates its position and, based on the second mapping information, determines its angle of arrival. Based on the angle of arrival and the first mapping information, the first apparatus 504a determines its particular pool that defines the particular set of signal and permutation sequences and the particular set of preambles.

The first apparatus 504a generates a random access message for transmission based on the particular pool and information to be transmitted. The generation of the random access message is described with reference to FIG. 7, which shows an example implementation of the first apparatus 504a.

As shown in FIG. 7, the first apparatus 504a includes an FEC encoder 702, a Compressed Sensing (CS) part encoder 704 and a payload encoder. The payload encoder includes a repetition unit 706, a permutation unit 708 and a scrambling unit 710. It will be appreciated that, in general, the first apparatus 504a may include more or fewer units than those shown.

The information to be transmitted (labelled “Info”) is encoded by the FEC encoder 702 to obtain encoded bits. Any suitable FEC code may be used, such as any of the types of FEC code mentioned above. The encoded bits are divided into two parts: preamble data bits (“Preamble”) and payload data bits (“Payload”). The preamble data bits are input to the CS part encoder 704. The CS part encoder 704 selects a CS preamble from the particular set of preambles defined by the particular pool associated with the location index of the first apparatus 504a. The CS part encoder 704 selects the CS preamble based on the preamble data bits. For example, the CS part encoder 704 may perform a binary-to-decimal conversion of the preamble data bits to obtain a CS preamble. An index of the selected CS preamble is input to the payload encoder. Based on the selected CS preamble, the payload encoder selects a pair of signature and permutation sequences from the particular set of signature and permutations defined by the signature and permutation pool associated with the location index of the first apparatus 504a. The payload data goes through repetition, permutation, and scrambling in accordance with the selected signature and permutation sequences (e.g. a data permutation and a bit-by-bit multiplication of the resulting sequence with the selected signature sequence is performed) to obtain a random access message to be transmitted by the first apparatus 504a.

The first apparatus 504 transmits the random access message to the network device 502. The processing of the random access message by the network device 502 is described with reference to FIG. 8, which shows an example implementation of the network device 502.

The network device 502 receives the random access message transmitted by the first apparatus 504a, as well as random access messages transmitted by other apparatus, such as the second apparatus 504b. The network device 502 thus receives a stream that includes preamble parts 802, Y_{P}, and data parts 804, Y_{D}. The preamble sequences that are present in the stream (e.g. the active preamble sequences) are detected by a Multi measurement Vector—Approximate Message Passing (MMV-AMP) unit 806. A single sequence may correspond to multiple apparatus with different location indices (e.g. in different regions). This may occur when the same sequence pool is reused for different regions. The detected preamble sequences are input to MUltiple SIgnal Classification (MUSIC) units 808 to estimate (e.g. detect) the angles of arrival of apparatus with the same preamble. The estimated angles of arrivals are used to determine channel estimates 820 and location indices for each apparatus.

The estimated indices and the estimated channels are input to a Repetition-Permutation-Scrambling (RPS) Multiple User Detection (MUD) unit 812, which decodes the payload parts by performing interference cancellation, data estimation, and improving channel estimation iteratively. The MUD unit 812 may be implemented in accordance with methods described in E. Nassaji, R. Soltani, M. Bashir, and D. Truhachev, “Spread Unsourced Random Access With an Iterative MIMO Receiver,” IEEE Communications Letters, vol. 26, no. 10, pp. 2495-2499 October 2022, doi: 10.1109/LCOMM.2022.3195410.

### Hierarchical Pool Design

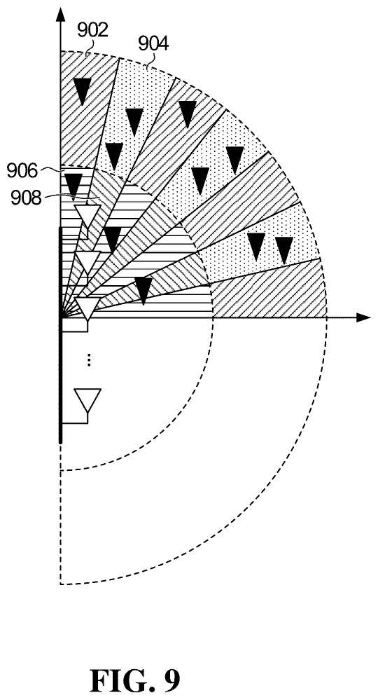

Another example method performed by the network device 502 and the first apparatus 504a is described with reference to FIG. 9. FIG. 9 shows the division of space around a network device into regions according to embodiments of the disclosure. As shown in FIG. 9, the space around the network device 502 is divided into regions based on angle of arrival and distance from the network device 502. As a result, in addition to the angle of arrival-based regions that are similar to those used in the example described above in respect of FIGS. 7 and 8, there is also a separation between apparatus that are near to the network device 502 (e.g. having a smaller range or a higher signal strength) and apparatus that are far from the network device 502 (e.g. having a larger range or a lower signal strength). In this example, neighbouring regions are associated with different pools. This may be illustrated by considering four of the regions shown in FIG. 9: the first region 902, the second region 904, the third region 906 and the fourth region 908. The first and second regions 902, 904, which are adjacent to one another, are the same distance away from the network device 502 but have different angles of arrival. The third and fourth regions 906, 908 are adjacent to the first and second regions 902, 904 respective and have the same angles of arrival as the first and second regions 902, but are closer to the network device 502. Each of the regions, including the first, second, third and fourth regions 902-908 are associated with a respective pool in a set of four of pools, with the shading of the region indicating the relevant pool. Each pool defines a set of possible values for a transmission feature. As illustrated, each pool is used for multiple regions, but adjacent regions are associated with different pools.

The hierarchical design allows for an additional enhancement to the methods described above. In some examples, the transmission feature may include the FEC code and/or modulation scheme. As such, this design enables more efficient transmission by providing the opportunity to allocate appropriate error-correction coding and modulation based on the distance of apparatus to the network device 502 as well as its angle of arrival. As apparatus that are near to the network device 502 (e.g. apparatus in regions such as the third region 906 or the fourth region 908) are expected to be received at the network device 502 with more power, higher rate FEC codes and/or higher order modulation may be used. For apparatus that are further from the network device 502 (e.g. apparatus in regions such as the first region 902 or the second region 904), lower order modulation and/or stronger (e.g. lower rate) FEC codes may be used. The regions and/or the pools may be designed based on characteristics of the space around the network device 502, such as active user density, fading channel conditions etc.

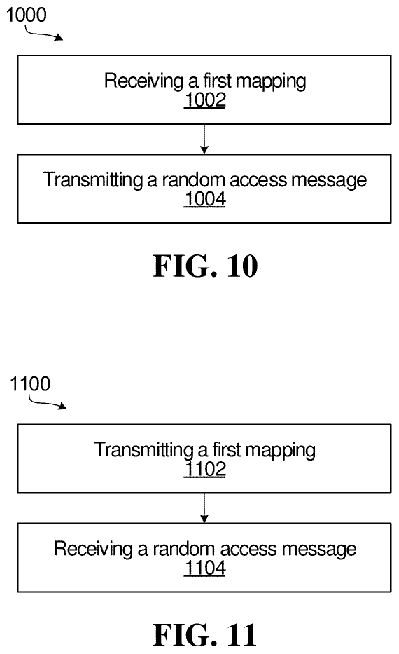

FIG. 10 shows a flowchart of a method 1000 performed by an apparatus (e.g. device) according to embodiments of the disclosure. The method 1000 may be performed by any suitable apparatus, such as either of the first apparatus 504a and the second apparatus 504b. The method 1000 may be performed by a communication device, such as an electronic device. In some embodiments, the method 1000 may be performed by a processor of the apparatus.

The method 1000 may involve, in step 1002, receiving first mapping information for a plurality of pools for a transmission feature. The first mapping information may be received from a network device, such as the network device 502. The transmission feature may include one or more of: a random access preamble, a signature and permutation sequence for payload encoding, a modulation scheme, and a forward error correction code for encoding. Each of the plurality of pools defines a set of possible values for the transmission feature. The set of possible values defined by a particular pool may be based on a number of active apparatus in a region associated with that pool. The quantity of values included in the plurality of possible values defined by a particular pool may be based on the number of active apparatus in a region associated with the pool.

The first mapping information associates a location indicator of the apparatus with a particular pool in the plurality of pools. The location indicator of the apparatus comprises one or more of: a range of the apparatus with respect to the network device, an angle of arrival at the network device from the apparatus, and a coverage enhancement level of the apparatus. The first mapping information may associate an index or identifier of the location indicator (e.g. an index representing that an angle of arrival is within a particular range of values) with the particular pool. The first mapping information may associate at least two different regions with a same pool in the plurality of pools. Additionally or alternatively, the first mapping information may associate two adjacent regions with different pools in the plurality of pools.

Step 1002 may be performed in accordance with step 602 described above.

The method 1000 may also involve the apparatus receiving second mapping information associating a geographical location of the apparatus with the location indicator of the apparatus. The apparatus may determine its location indicator based on the second mapping information and the geographical location of the apparatus. The apparatus may receive the second mapping information in accordance with step 604 described above.

In step 1004, the apparatus transmits, to the network device, a random access message according to a particular value of the transmission feature. The particular value is selected from a particular set of possible values defined by the particular pool. The particular pool is selected from the plurality of pools based on the first mapping information and the location indicator of the apparatus. Step 1004 may be performed in accordance with step 606 described above.

In a further aspect, the apparatus configured to perform the method 1000 is provided. The apparatus may include a processor and a memory (e.g. a non-transitory processor-readable medium). The memory stores instructions (e.g. processor-readable instructions) which, when executed by a processor of the apparatus, cause the apparatus to perform the method 1000. In another aspect, the memory may be provided (e.g. separate to the apparatus).

FIG. 11 shows a flowchart of a method 1100 performed a network device (e.g. a base station) according to embodiments of the disclosure. The method 1100 may performed by any suitable network device, such as the network device 502. In some embodiments, the method 1100 may be performed by a processor of the network device 502.

In step 1102, the network device transmits, to an apparatus, first mapping information for a plurality of pools for a transmission feature. The apparatus may be the first apparatus 504a or the second apparatus 504b, for example. The network device may transmit the first mapping information to the apparatus in accordance with step 602 described above.

Each of the plurality of pools defines a set of possible values for the transmission feature. The transmission feature may include one or more of: a random access preamble, a signature and permutation sequence for payload encoding, a modulation scheme, and a forward error correction code for encoding. The method 1100 may further involve, prior to step 1102, the network device determining the set of possible values defined by a particular pool and/or assigning the pools to location indicators (e.g. to regions). The network device may determine the set of possible values defined by a particular pool based on a number of active apparatus in a region associated with that pool. For example, the network device may determine the quantity of values included in the plurality of possible values defined by a particular pool based on the number of active apparatus in a region associated with the pool. The quantity of values may be higher for regions which have a higher number of active apparatus.

The first mapping information associates a location indicator of the apparatus with a particular pool in the plurality of pools. The location indicator of the apparatus may include one or more of: a range of the apparatus with respect to the network device, an angle of arrival at the network device from the apparatus, and a coverage enhancement level of the apparatus. The first mapping information may associate an index or identifier of the location indicator (e.g. an index representing that an angle of arrival is within a particular range of values) with the particular pool. The first mapping information may associate at least two different regions with a same pool in the plurality of pools. Additionally or alternatively, the first mapping information may associate two adjacent regions with different pools in the plurality of pools.

The method 1100 may also involve the network device transmitting, to the apparatus, second mapping information associating a geographical location of the apparatus with the location indicator of the apparatus. The transmission of the second mapping information to the apparatus may be performed in accordance with step 604 described above.

In step 1104, the network device receives a random access message transmitted, by the apparatus, according to a particular value of the transmission feature. The particular value is selected (e.g. by the apparatus) from a particular set of possible values defined by the particular pool. The particular pool is selected (e.g. by the apparatus) from the plurality of pools based on the first mapping information and the location indicator of the apparatus. The network device may receive the random access message from the apparatus in accordance with step 606 described above.

In a further aspect, the network device configured to perform the method 1100 is provided. The network device may include a processor and a memory (e.g. a non-transitory processor-readable medium). The memory stores instructions (e.g. processor-readable instructions) which, when executed by a processor of the network device, cause the network device to perform the method 1100. In another aspect, the memory may be provided (e.g. separate to the network device).

It should be appreciated that, although the steps of the methods provided herein may be described a particular order, the present disclosure is not limited as such. The skilled person will appreciate that the steps of the methods described herein may be performed in any suitable order, including in an order different to the order explicitly described herein. For example, step 602 in the method 600 may be performed before, during or after step 604. It will also be appreciated that, in some embodiments, some steps of the methods described herein may be omitted. For example, step 604 may be omitted from the method 600.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method performed by an apparatus, the method comprising:
receiving first mapping information for a plurality of pools for a transmission feature, each pool of the plurality of pools defining a respective set of possible values for the transmission feature, the first mapping information associating a location indicator of the apparatus with a pool in the plurality of pools; and
transmitting, to a network device, a random access message according to a value of the transmission feature, wherein a set of possible values defined by the pool includes the value, and wherein the pool is selected based on the first mapping information and the location indicator of the apparatus.

2. The method of claim 1, wherein the transmission feature comprises one or more of:
a random access preamble;
a signature and permutation sequence for payload encoding;
a modulation scheme; or
a forward error correction code for encoding.

3. The method of claim 1, wherein the location indicator of the apparatus comprises one or more of:
a range of the apparatus with respect to the network device;
an angle of arrival at the network device from the apparatus; or
a coverage enhancement level of the apparatus.

4. The method of claim 1, wherein the first mapping information associates at least two different regions with a same pool in the plurality of pools.

5. The method of claim 1, wherein the first mapping information associates two adjacent regions with different pools in the plurality of pools.

6. A method performed by a network device, the method comprising:
transmitting, to an apparatus, first mapping information for a plurality of pools for a transmission feature, each pool of the plurality of pools defining a respective set of possible values for the transmission feature, the first mapping information associating a location indicator of the apparatus with a pool in the plurality of pools; and
receiving, from the apparatus, a random access message according to a value of the transmission feature, wherein a particular set of possible values defined by the pool includes the value, and wherein the pool is selected based on the first mapping information and the location indicator of the apparatus.

7. The method of claim 6, wherein the transmission feature comprises one or more of:
a random access preamble;
a signature and permutation sequence for payload encoding;
a modulation scheme; or
a forward error correction code for encoding.

8. The method of claim 6, wherein the location indicator of the apparatus comprises one or more of:
a range of the apparatus with respect to the network device;
an angle of arrival at the network device from the apparatus; or
a coverage enhancement level of the apparatus.

9. The method of claim 6, wherein the first mapping information associates at least two different regions with a same pool in the plurality of pools.

10. The method of claim 6, wherein the first mapping information associates two adjacent regions with different pools in the plurality of pools.

11. An apparatus comprising:
at least one processor; and
a memory storing instructions which, when executed by the at least one processor, cause the apparatus to:
receive first mapping information for a plurality of pools for a transmission feature, each pool of the plurality of pools defining a respective set of possible values for the transmission feature, the first mapping information associating a location indicator of the apparatus with a pool in the plurality of pools; and
transmit, to a network device, a random access message according to a value of the transmission feature, wherein a set of possible values defined by the pool includes the value, and wherein the pool is selected based on the first mapping information and the location indicator of the apparatus.

12. The apparatus of claim 11, wherein the transmission feature comprises one or more of:
a random access preamble;
a signature and permutation sequence for payload encoding;
a modulation scheme; or
a forward error correction code for encoding.

13. The apparatus of claim 11, wherein the location indicator of the apparatus comprises one or more of:
a range of the apparatus with respect to the network device;
an angle of arrival at the network device from the apparatus; or
a coverage enhancement level of the apparatus.

14. The apparatus of claim 11, wherein the first mapping information associates at least two different regions with a same pool in the plurality of pools.

15. The apparatus of claim 11, wherein the first mapping information associates two adjacent regions with different pools in the plurality of pools.

16. A network device comprising:
at least one processor; and
a memory storing instructions which, when executed by the at least one processor, cause the network device to:
transmit, to an apparatus, first mapping information for a plurality of pools for a transmission feature, each pool of the plurality of pools defining a respective set of possible values for the transmission feature, the first mapping information associating a location indicator of the apparatus with a pool in the plurality of pools; and
receive, from the apparatus, a random access message according to a value of the transmission feature, wherein a set of possible values defined by the pool includes the value, and wherein the pool is selected based on the first mapping information and the location indicator of the apparatus.

17. The network device of claim 16, wherein the transmission feature comprises one or more of:
a random access preamble;
a signature and permutation sequence for payload encoding;
a modulation scheme; or
a forward error correction code for encoding.

18. The network device of claim 16, wherein the location indicator of the apparatus comprises one or more of:
a range of the apparatus with respect to the network device;
an angle of arrival at the network device from the apparatus; or
a coverage enhancement level of the apparatus.

19. The network device of claim 16, wherein the first mapping information associates at least two different regions with a same pool in the plurality of pools.

20. The network device of claim 16, wherein the first mapping information associates two adjacent regions with different pools in the plurality of pools.
